(19) United States
(12) Patent Application Publication
(10) Pub. No.: US 2009/0195483 A1
(43) Pub. Date: Aug. 6, 2009

(54) USING STANDARD CURRENT CURVES TO CORRECT NON-UNIFORMITY IN ACTIVE MATRIX EMISSIVE DISPLAYS

(75) Inventors: Walter Edward Naugler, JR., Katy, TX (US); Keunmyung Lee, Palo Alto, CA (US); Jose Ignacio Arreola, Mountain View, CA (US)

Correspondence Address: FENWICK & WEST LLP, SILICON VALLEY CENTER, 801 CALIFORNIA STREET, MOUNTAIN VIEW, CA, 94041, US

(73) Assignee: LEADIS TECHNOLOGY, INC., Sunnyvale, CA (US)

(21) Appl. No.: 12/027,000

(22) Filed: Feb. 6, 2008

(51) Int. Cl. G09G 3/30

(52) U.S. Cl. 345/76

(57) ABSTRACT

A plurality of gray level versus OLED current curves are generated by measuring many OLED panels from a stable manufacturing process, and those curves are stored as standard gray level versus OLED current curves. When a new OLED display is manufactured from the process, each of its sub-pixels is characterized as having the characteristics of one of the pre-generated standard gray level versus OLED current curves, based on a gray level versus OLED current measurement at a single gray level. This drastically reduces the time it takes to determine the TFT gate voltage versus OLED current characteristics of the sub-pixels in the OLED display. The OLED display can use the selected one of the pre-generated standard gray level versus OLED current curves to correct non-uniformities of the sub-pixels in the OLED display caused by non-uniform TFTs in the active matrix.

### BACKGROUND OF THE INVENTION

1. Field of the Invention

The present invention relates to correcting non-uniformities in an active matrix emissive display.

2. Description of the Related Arts

An OLED display is generally comprised of an array of organic light emitting diodes (OLEDs) that have carbon-based films disposed between two charged electrodes. Generally one electrode is comprised of a transparent conductor, for example, indium tin oxide (ITO). Generally, the organic material films are comprised of a hole-injection layer, a hole-transport layer, an emissive layer and an electron-transport layer. When voltage is applied to the OLED, the injected positive and negative charges recombine in the emissive layer and transduce electrical energy to light energy. Unlike liquid crystal displays (LCDs) that require backlighting, OLED displays are self-emissive devices—they emit light rather than modulate transmitted or reflected light. Accordingly, OLEDs are brighter, thinner, faster and lighter than LCDs, and use less power, offer higher contrast and are cheaper to manufacture.

An OLED display typically includes a plurality of OLEDs arranged in a matrix form including a plurality of rows and a plurality of columns, with the intersection of each row and each column forming a pixel of the OLED display. An OLED display is generally activated by way of a current driving method that relies on either a passive-matrix (PM) scheme or an active-matrix (AM) scheme.

In a passive matrix OLED display, a matrix of electrically-conducting rows and columns forms a two-dimensional array of picture elements called pixels. Sandwiched between the orthogonal column and row lines are thin films of organic material of the OLEDs that are activated to emit light when current is applied to the designated row and column lines. The brightness of each pixel is proportional to the amount of current applied to the OLED of the pixel. While PM OLEDs are fairly simple structures to design and fabricate, they demand relatively expensive, current-sourced drive electronics to operate effectively and are limited as to the number of lines because only one line can be on at a time and therefore the PM OLED must have instantaneous brightness equal to the desired average brightness times the number of lines. Thus, PM OLED displays are typically limited to under 100 lines. In addition, their power consumption is significantly higher than that required by an active-matrix OLED. PM OLED displays are most practical in alpha-numeric displays rather than higher resolution graphic displays.

An active-matrix OLED (AMOLED) display is comprised of OLED pixels that have been deposited or integrated onto a thin film transistor (TFT) array to form a matrix of pixels that emit light upon electrical activation. In contrast to a PM OLED display, where electricity is distributed row by row, the active-matrix TFT backplane acts as an array of switches coupled with sample and hold circuitry that control and hold the amount of current flowing through each individual OLED pixel during the total frame time. The active matrix TFT array continuously controls the current that flows to the OLEDs in the each of pixels, signaling to each OLED how brightly to illuminate.

FIG. 1 illustrates a conventional active matrix OLED display. While the example of FIG. 1 is illustrated as an OLED display, other emissive-type displays would have structures similar to that illustrated in FIG. 1. Referring to FIG. 1, the OLED display panel includes a plurality of rows Row 1, Row 2, . . . , Row Y and a plurality of columns Col. 1, Col. 2, . . . , Col. X arranged in a matrix. The intersection of each row and each column forms a pixel of the OLED display. The OLED display also includes a Gamma network 104, row drivers 116-1, 116-2, . . . , 116-y, column drivers 114-1, 114-2, . . . , 114-x, and a timing controller 112.

For a color OLED display, each pixel includes 3 sub-pixels that have identical structure but emit different colors (R, G, B). For simplicity of illustration, FIG. 1 illustrates only one sub-pixel (denoted as dashed line boxes in FIG. 1, such as box 120) corresponding to one of the R, G, B colors per pixel at the intersection of each row and each column. However, in real OLED display panels, each pixel includes three identical ones of the sub-pixel structure 120 as illustrated in FIG. 1. As shown in FIG. 1, the active drive circuitry of each sub-pixel 120 includes TFTs T1 and T2 and a storage capacitor Cs for driving the OLED D1 of the sub-pixel 120. In the following explanation of FIG. 1, the type of the TFTs T1 and T2 is an n-channel TFT. However, note that p-channel TFTs may also be utilized in the active matrix.

Image data 110 includes data indicating which sub-pixel 120 of the OLED display should be turned on and the brightness of each sub-pixel. Image data 110 is sent by an image rendering device (e.g., graphics controller (not shown herein)) to the timing controller 112, which coordinates column and row timing. The timing controller 112 sends digital numbers (DN) 101 indicating pixel brightness to the gamma network 104. Image data 110 is coupled to the gate lines 150 of each row through its corresponding row driver 116-1, 116-2, . . . , 116-y. Row drivers 116-1, 116-2, . . . , 116-y drive the gate line 150 so that the gate lines 150 carry an over-voltage of 25 to 30 volts when active. The gates of TFTs T2 of each sub-pixel in a row are connected to gate line 150 of each row to enable TFTs T2 to operate as switches. The data lines 160 are connected to the drains of TFTs T2 in each column. When the gate line 150 becomes active for a row based on the image data 110, all the TFTs T2 in the row are turned on. The Gamma network 104 generates the T1 gate voltages 102 (brightness) to be applied to each TFT T1 in the row when the sub-pixel 120 is turned on, based on digital numbers (DNs) 101 corresponding to such gate voltage 102. Column drivers 114-1, 114-2, . . . , 114-x provides high analog voltages 160 to be applied to the gates of TFTs T1, corresponding to the T1 gate voltages 102. The voltages 102 representing pixel brightness values are distributed from the Gamma network 104 to all the column drivers 114-1, 114-2, . . . , 114-x in parallel. Under control of the timing controller 112, for example, row driver 1 (116-1) is activated and all the voltages 102 placed on the column drivers 114-1, 114-2, . . . , 114-x are downloaded to the TFT T1s in row 1. Timing controller 112 then proceeds to send brightness data for the next row (e.g., row 2) using the row driver 2 (116-2) to column drivers 114-1 through 114-x and activating row 2 and so forth, until all rows have been activated and brightness data for the total frame has been downloaded and all the sub-pixels are turned on to the brightness indicated by the image data 110.

The source of TFT T2 is connected to the gate of TFT T1 and to one side of storage capacitor Cs. The drain of TFT T1 is connected to positive supply voltage VDD. The other side of storage capacitor Cs is also connected, for example, to the positive supply voltage VDD and to the drain of TFT T1. Note that the storage capacitor Cs may be tied to any reference electrode in the pixel. The source of TFT T1 is connected to the anode of OLED D1. The cathode of OLED D1 is connected to negative supply voltage Vss or common Ground. The analog voltages 160 are downloaded to the OLED display a row at a time.

When TFT T2 is turned on, the analog T1 gate voltage 160 is applied to the gate of each TFT T1 of each sub-pixel 120, which is locked by storage capacitor Cs. When the row scan moves to the next row, the gate voltage of TFT T1 is locked for the frame time until the next gate voltage for that sub-pixel is sent by the column drivers 114-1, 114-2, . . . , 114-n. In other words, the continuous current flow to the OLEDs is controlled by the two TFTs T1, T2 of each sub-pixel. TFT T2 is used to start and stop the charging of storage capacitor Cs, which provides a voltage source to the gate of TFT T1 at the level needed to create a constant current to the OLED D1. As a result, the AMOLED display operates at all times (i.e., for the entire frame scan), avoiding the need for the very high currents required for passive matrix operation. The TFT T2 samples the data on the data line 160, which is held as charge stored in the storage capacitor Cs. The voltage held on the storage capacitor Cs is applied to the gate of the second TFT T1. In response, TFT T1 drives current through the OLED D1 to a specific brightness depending on the value of the sampled and held data signal as stored in the storage capacitor Cs.

FIG. 2 illustrates a conventional gamma network used with an active matrix OLED display. The gamma network 104 is a circuit that converts the brightness data for a sub-pixel from a digital number (DN) representing the desired gray level (brightness) to an analog voltage, which will produce the right amount of current to drive OLED D1 to emit the desired brightness when the analog voltage 160 is applied to the gate of TFT T1 in the sub-pixel 120 (See FIG. 1). For example, the gamma network 104 in FIG. 2 is a conventional 8 bit gamma network used with DN (8 bits) ranging from 0 to 255. Gamma network 104 includes a counter 202, a shift register (SRI) 204, a series of resistors (R0, . . . R30, . . . R191, . . . , R223, . . . , R253, R254) (255 resistors for an 8 bit system) and 256 switches GT0, GT1, . . . , GT255. The gate of each switch GT0, GT1, . . . , GT255 is coupled to the corresponding one of the bits of shift register 204. When the corresponding binary bit at the shift register 204 is “1” the corresponding switch (GT0, GT1, . . . , GT255) is turned on, and when the binary bit at the shift register 204 is “0” the corresponding switch (GT0, GT1, . . . , GT255) is turned off. DN 101 can be any value between 0 and 255 for an eight bit system. Counter 202 counts up to the value of DN 101 sent to the Gamma network 104, causing shift register 204 to move its output to the gate of the gamma table switches GT(DN). For example, if a DN of 185 indicating brightness level 185 was sent to counter 202, shift register 204 would move its output to GT185, thereby switching switch GT185 on. Gamma network 104 is essentially a voltage divider with 256 taps corresponding to 256 gray levels (brightnesses). The voltage at tap 185 is controlled by switch GT185, which when turned on delivers to the gate of the TFT T1 in the specified sup-pixel the voltage calculated to produce a gray level brightness corresponding to DN 185.

The voltage 102 output from the gamma network 104 is designed to produce a series of currents from TFT T1 that will produce 256 levels (in an 8 bit display system) of light emission from OLED D1 conforming to the brightness response of the human eye. The human eye has a linear response approximate to the square root of brightness. That is, for the human eye to experience a doubling of brightness, the light flux has to be increased approximately 4 times. This relationship of eye response to light flux (brightness) is known as the gamma function (γ), which is not exactly 2 but closer to 2.2. In general, gamma gives contrast to the image. If, for example, gamma is reduced to 1 (a linear relationship between eye response and light), the images produced would have very low contrast, and be flat and very uninteresting. If gamma is increased, contrast of the image increases. Note that gamma refers to the relationship between the eye and light—not current or voltages. OLED emission is produced by current flowing through OLED D1 as controlled by TFT T1. Thus, it is the function of the gamma network 104 to produce an appropriate voltage, which will produce appropriate current through OLED D1, which will produce light with the correct (or desired) gamma function. The emission of light from OLED material is linear to the current. That is, in order to double the luminance (expressed as cd/m²—candelas per meter squared), current is doubled.

The brightness values in an image are represented as digital numbers (DNs). For an 8-bit display system, DNs range from 0 to 255. The light values are called gray scale levels and are linear to the human eye. Thus, a doubling of DNs is perceived by the human eye as a doubling of brightness. The gamma relation between DNs and the current of TFT T1 can be determined as follows. FIG. 3A illustrates the gamma curve showing the relationship between the digital number (DN) and the OLED current. Note that gamma curve 300 is not linear but has a curve with a changing slope. The exact shape of the gamma curve 300 is determined by the desired gamma. The gamma curve 300 shown in FIG. 3A is for a gamma of 2.

FIG. 3B is a table showing example resistors, voltages and currents for the gamma network in FIG. 2. Referring to FIGS. 2 and 3B, note that the resistors (R0 through R254) are grouped with roughly 32 resistors per group, except Group 0 that includes no resistor, although all the resistors are not shown in FIG. 2 for simplicity of illustration. Each resistor group (Group 0 through Group 8) is associated with a tap voltage Vtap0 through Vtap7 and Vgamma. The tap voltages, for example, are bounded by a minimum voltage (1.541 volts) and a maximum voltage (Vgamma, 12.000 volts). The tap voltages coupled with the minimum and maximum voltages establish the gamma current curve 300 with the aid of resistors R0 through R254. The tap voltages are voltage sources, and thus the voltage established between each resistor is determined by the current drawn between the tap voltages. The greater the number of tap voltages, the better current conformation is to the gamma curve. In the example of FIG. 3B, nine voltage sources produce the voltages at each resistor (R0 through R254), which in turn use TFT T1 to produce the current that conforms to the gamma curve 300. By adjusting the tap voltages, the gamma current curve 300 will change.

The gate voltage 102 to the TFT T1 is determined by the tap voltages, resistors, and which of the switches GT0, . . . , GT255 are turned on. For example, when DN is 255, counter 202 moves the output of shift register 204 to the gate line for GT255; thereby connecting Vgamma voltage to line 102 which connects to the column driver of the selected sub-pixel. Since the Vgamma voltage is the maximum voltage put out by the Gamma Network 104, the maximum voltage is placed on the gate of T1 in the selected sub-pixel. This maximum voltage causes TFT T1 in the selected sub-pixel to supply the current to OLED D1 for the brightest gray level for the sub-pixel. The voltage value of Vgamma is determined by the design of T1 and the designed top brightness of the sub-pixel. The methods of doing such design work are well known in the display industry. The table in FIG. 3B is an example of design voltages for Vgamma and the taps on the voltage divider. For example, the design voltage for Vgamma from FIG. 3B is 12 V. As a further example, if the sub-pixel is scheduled by the image data to be black (off) then DN 0 is sent to the gamma network 104 causing counter 202 to move the output of shift register 204 to switch GT0 connecting Vtap0 to the output line 102. The voltage value of Vtap0 from the table in FIG. 3B is 1.541 Volts, which when supplied to the gate of T1 through the column driver for the selected sub-pixel causes the current supplied to OLED D1 to be less than the threshold current for OLED D1 and therefore, no light will be emitted from the sub-pixel for the frame. The taps on the gamma network voltage divider 104 will be between Vgamma and Vtap0 (12 Volts and 1.541 Volts, respectively, in the example). As a further example, if DN 227 is sent to gamma network 104, counter 202 will move the output of shift register 204 to the gate line for switch GT227 connecting to the aforesaid voltage divider 104 at a point between Vgamma and Vtap7. The exact voltage connected through switch GT227 to output line 102, and thus, to the gate of TFT T1 in the selected sub-pixel will be determined by the voltage drop from Vgamma to Vtap7, which from the table in FIG. 3B is determined to be 12 Volts−10.729 Volts=1.271 Volts. There are 31 resistors (255−224=31) between Vgamma and Vtap7; therefore, the voltage is dropped in 31 equal decrements from Vgamma to Vtap, because all 31 resistors are of the same value, which from the FIG. 3B is 7843 Ohms each. Each voltage drop, therefore, is 1.271/31=0.041 volts. There are 28 resistors (255−227) between the GT227 tap and the GT255 tap; therefore, the voltage drop is 28×0.041=1.148 Volts. The exact voltage sent to the selected sub-pixel through output line 102 and the column driver to the gate of TFT T1 is 12 volts−1.148 Volts=10.852 Volts, which is the T1 gate voltage designed to supply the required current to OLED D1 to emit brightness corresponding to gray level 227. The other voltages at the various gray levels are calculated in the same manner.

Referring back to FIG. 1, the OLED display requires regulated current in each sub-pixel to produce a desired brightness from the pixel. Ideally, the TFTs T1 in each sub-pixel 120 should be good current sources that deliver the same current for the same gate voltage over the lifetime of the OLED display. Also each current source TFT T1 in the active TFT matrix must deliver the same current for the same data voltage stored in the storage capacitor Cs in order that the display is uniform.

Note that there are two types of thin film semiconductors in popular use in the active matrix display industry: amorphous silicon (a-Si) and poly-silicon (p-Si). Emissive displays, such as the active matrix OLED (AMOLED) displays, require high current and stability not available in the a-Si TFTs and therefore typically use p-Si for the TFTs T1, T2. a-Si is converted to p-Si by laser annealing the a-Si to increase the crystal grain size and thus convert a-Si to p-Si. The larger the crystal grain size, the faster and more stable is the resulting semiconductor material. Unfortunately the grain size produced in the laser anneal step is not uniform due to a temperature spread in the laser beam. Thus, uniform TFTs T1, T2 are very difficult to produce and thus the current supplied by TFTs T1 in conventional OLED displays is often non-uniform, resulting in non-uniform display brightness. Non-uniform TFTs T1 throughout the OLED display causes “Mura” or streaking in the OLED displays made with p-Si TFTs. In other words, TFTs T1 may produce different OLED current due to its non-uniformities from sub-pixel to sub-pixel, even if the same gate voltage is applied to the TFTs T1. Therefore, it is necessary to compensate for non-uniformities in the TFTs T1 by applying corrected (compensated) T1 gate voltages that are different from the intended gate voltage from the graphics board (not shown) to the TFTs T1. This can be done by measuring the gray level (gate voltage) versus current characteristics of the TFTs T1 for each sub-pixel, and using such measurement data to compensate for the non-uniformities in TFTs T1 when driving the TFTs T1 with the gate voltage 102 through the gamma network 104.

However, measuring the gate voltage versus current characteristics of the TFTs T1 for each sub-pixel of an OLED display takes a long time. The conventional method of pixel characterization is to measure multiple voltage/current points along the voltage current curve of the current driving TFTs T1 in the active matrix. High resolution displays have millions of sub-pixels. For example, a wide VGA display has 1,152,000 sub-pixels. If eight voltage/current points are measured for each sub-pixel, this requires 9,216,000 measurements. A single measurement can take up to 200 microseconds or longer. Therefore, the time it takes to measure an entire OLED display may be greater than 30.72 minutes. Such long measurement time is impractical on an actual OLED display production line. In addition there are other practical considerations. The actual time to make a measurement is a trade-off between current magnitude and signal to noise ratio. Current measurement is often accomplished by charging or discharging a capacitor during a specified time. The larger the current, the longer the time required for the current to settle and make the measurement. Therefore, in the interest of short measurement time, measurement using low current is desired. However, low current has low signal to noise ratio, and thus multiple measurements may have to be made to cancel out random noise, which takes longer. In addition, low current output of a thin film transistor is subject to large variations due to non-uniform electrical characteristics. To get good accuracy in the low current region (low gray levels), many more points on the voltage/current curve should be measured. Therefore, it may take even longer than 30 minutes to take reliable measurements of the gate voltage versus current characteristics of the TFTs T1 for each sub-pixel of an OLED display to achieve highly uniform correction. Such long time is not acceptable in an actual production line.

Thus, there is a need for a better way to measure the gray level (gate voltage) versus current characteristics of the TFTs driving each sub-pixel of an OLED display.

### SUMMARY OF THE INVENTION

Embodiments of the present invention include an efficient method of calibrating OLED sub-pixels to correct non-uniformities in the OLED drive TFTs. According to embodiments of the present invention, a plurality of gray level (DN) versus OLED current curves are generated by measuring many OLED panels made by a stable manufacturing process. The curves are stored as standard gray level versus OLED current curves. When a new OLED display is manufactured from the process, each of its sub-pixels is characterized as having the characteristics of one of the pre-generated standard gray level versus OLED current curves, based on OLED current measurement at a single gray level for each sub-pixel. This substantially reduces the time it takes to determine the TFT gate voltage versus OLED current characteristics of the sub-pixels in the OLED display. Then, the OLED display can use the selected one of the pre-generated standard gray level versus OLED current curves to correct non-uniformities of that sub-pixel in the OLED display caused by non-uniform TFTs in the active matrix.

In one embodiment, a method of correcting non-uniformities of an active matrix drive circuit configured to drive current through a plurality of emissive display elements is disclosed. The method comprises measuring sub-pixel current corresponding to a plurality of gray levels for a plurality of sub-pixels of the emissive display, determining first mappings between the gray levels and the corresponding sub-pixel current for a highest current sub-pixel through which highest current flow is measured for a given gray level, determining second mappings between the gray levels and the corresponding sub-pixel current for a lowest current sub-pixel through which lowest current flow is measured for the given gray level, and determining third mappings between the gray levels and the corresponding sub-pixel current for one or more intermediate current sub-pixels with intermediate current flow between the lowest current flow and the highest current flow for the given gray level.

In addition, the method may further comprise measuring sub-pixel current corresponding to a single gray level for a plurality of sub-pixels of another emissive display to calibrate for each sub-pixel of said another emissive display, selecting one of the first mappings, the second mappings, and the third mappings as a matching mapping between the gray levels and the corresponding sub-pixel current, and for each sub-pixel of said another emissive display storing the matching mappings in the emissive display. The digital numbers representing desired gray levels for the sub-pixels of the emissive display are converted to corrected digital numbers using the stored matched mappings for each sub-pixel. The corrected digital numbers are used in a gamma network to determine the appropriate voltages to apply to the drive transistors configured to drive the emissive elements of the emissive display. In one embodiment, the emissive display may be an active matrix organic light-emitting diode (AMOLED) display and the emissive elements are organic light-emitting diodes (OLEDs).

According to the present invention, the amount of time needed to take measurements of the current characteristics of the OLED pixels is substantially reduced. By assigning OLED sub-pixels to one of a plurality of predetermined standard curves based on a single current measurement, a substantial amount of time may be saved in the OLED production calibration process.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates a conventional active matrix OLED display.

FIG. 2 illustrates a conventional gamma network used with an active matrix OLED display.

FIG. 3A illustrates a gamma curve showing the relationship between the digital number (DN) and the OLED current.

FIG. 3B is a table showing example resistors, voltages and currents for the gamma network in FIG. 2.

FIG. 4A is a flowchart illustrating a method of generating standard gray level-current curves of an AMOLED display, according to one embodiment of the present invention.

FIG. 4B is a flowchart illustrating a method of generating standard gray level-—current curves of an AMOLED display, according to another embodiment of the present invention.

FIG. 4C is a flowchart illustrating a method of using the standard gray level-current curves in an AMOLED display, according to one embodiment of the present invention.

FIG. 5A illustrates the standard voltage (gray level)-current curves of an AMOLED display, determined by the method of FIG. 4A according to one embodiment of the present invention.

FIG. 5B illustrates the standard voltage (gray level)-current curves of an AMOLED display, determined by the method of FIG. 4B, according to another embodiment of the present invention.

FIG. 5C illustrates a standard gray level-current curve of an AMOLED display represented by a polynomial equation, according to one embodiment of the present invention.

FIG. 5D illustrates a standard current-gray level curve of an AMOLED display represented by another polynomial equation, according to another embodiment of the present invention.

FIG. 6 illustrates an active matrix OLED display using the standard gray level-current curves, according to one embodiment of the present invention.

FIG. 7 illustrates the gamma curve selection circuit using the standard gray level-current curves, according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention takes advantage of the fact that the OLED display manufacturing process at factories can be stabilized and are in fact stabilized in some leading OLED leading companies. If the OLED display manufacturing process at factories is stable, the gate voltage versus TFT T1 drain current characteristics of the OLED display may differ from sub-pixel to sub-pixel in the OLED display but would be repeated in many sub-pixels over a number of batches of OLED displays manufactured in the manufacturing process. Thus, a plurality of gate voltage (gray level) versus OLED current curves are generated by measuring many OLED panels from the stable manufacturing process, and those curves are stored as standard gate voltage (gray level) versus OLED current curves. When a new OLED display is manufactured from the process, each of its sub-pixels is characterized as having the characteristics of one of the pre-generated standard gray level (gate voltage) versus OLED current curves, based on a gate voltage measurement at a single gray level. This drastically reduces the time it takes to determine the TFT gate voltage versus OLED current characteristics of the sub-pixels in the OLED display. Then, the OLED display can use the selected one of the pre-generated standard gray level (gate voltage) versus OLED current curves to correct non-uniformities of that sub-pixel in the OLED display caused by non-uniform TFTs in the active matrix.

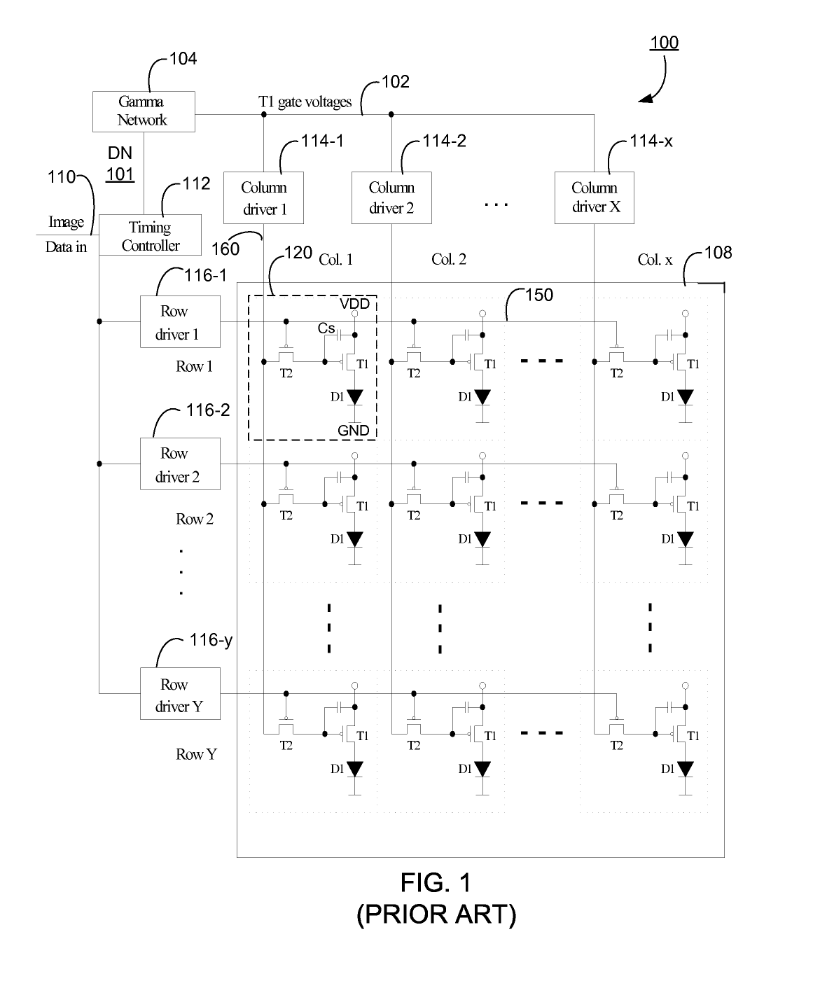

Before explaining how to generate such standard gray level (gate voltage) versus OLED current curves, the following discussion first shows why the sub-pixels in OLED display would exhibit characteristics of unique, non-crossing gray level (gate voltage) versus OLED current curves. Note that the primary electrical parameters that establish the gate voltage versus drain current of the drive TFT T1 (see FIG. 1) are effective charge carrier mobility and threshold voltage. For purposes of illustration herein, the TFT T1 is assumed to be an n-channel TFT, although the TFTs can also be p-channel TFTs. The threshold voltage is the voltage that needs to be applied to the gate of the TFT T1 to neutralize charges in the channel and at the interface of the gate oxide/semiconductor when no voltage is applied from the source to the drain. It is known that the equation I_{D}=μ·k₁·(V_{G}−Vₜₕ)^{2.}. . . (Equation 1) approximately holds, where I_{D} is the drain current of TFT T1, μ is the effective electron mobility, k₁ is gate capacitance per unit area of TFT T1, V_{G} is the applied gate voltage (data voltage) 160, and Vₜₕ is the threshold voltage of TFT T1. Note that the effective electron mobility, μ, is a linear variable, and Vₜₕ is a squared variable. The two variables μ and Vₜₕ are linked together, because they both depend to a high degree on the grain size of the semiconductor material used in the TFT T1. The threshold voltage Vₜₕ is determined by Vₜₕ=(−e·n₀·dₛₑₘᵢ·d_{diel})/(ε₀·Εᵣ) . . . (Equation 2), where e is charge, n₀ is charge density, dₛₑₘᵢ is the thickness of the semiconductor material of the thin film in the TFT T1, d_{diel} is the thickness of the gate dielectric of TFT T1, ε₀ is the permittivity of vacuum, and εᵣ is the dielectric constant of the gate dielectric of TFT T1.

Equation (2) shows a linear relationship between charge density n₀ and threshold voltage Vₜₕ. The charge density n₀ is affected by dangling silicon bonds at the surface of the semiconductor grains of the TFT T1. The greater the surface area is, the greater the Vₜₕ. The surface area of the TFT T1 is related to grain size by S_{G}=π·D_{G}²·N_{G} . . . (Equation 3), where S_{G} is the grain surface area, D_{G} is the diameter of the grain, and N_{G} is the number of grains. Also, V_{G}=(π·D_{G}³)/6 . . . (Equation 4), where V_{G} is the grain volume. According to Equation 3, as the diameter of the grains are cut in half, the surface area decrease by four times. According to Equation 4, however, the volume decreases by eight times and therefore, the number of grains in a unit volume increase by eight times. This results in a net increase in the surface area by double.

If it is assumed that the grains in the semiconductor of the TFT T1 are lined up and touching along the channel from source to drain, then the number of grain interfaces is the length of the channel from source to drain divided by the diameter of the grains. The electrons travel at top speed within a grain, but slow down to cross the boundary from one grain to the next grain. Therefore the effective mobility of the electron is determined (among other parameters) by the number of grain boundaries the electron has to cross between the source and drain of the TFT T1. When the diameter of the grain is reduced to half, the number of grain boundaries double, thereby causing the effective electron mobility to be reduced approximately to half. Thus, it can be expected that as the grain size is reduced, Vₜₕ will increase linearly and the effective mobility will decrease linearly. This relationship between the threshold voltage and the electron mobility ensures that TFTs T1 in the OLED display would have a characteristic of one of a plurality of unique, non-crossing gate voltage vs. current curves.

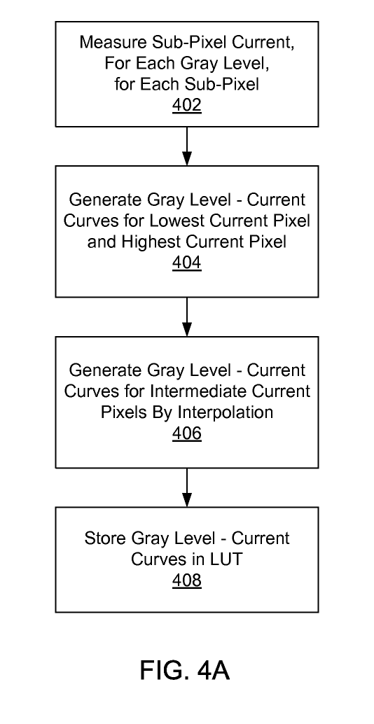

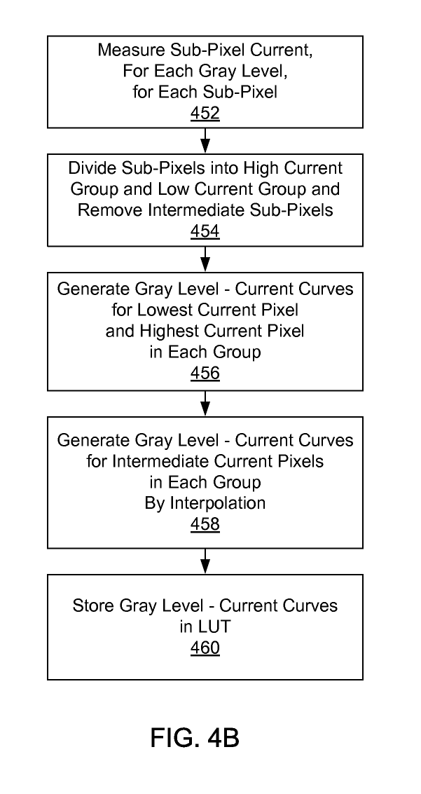

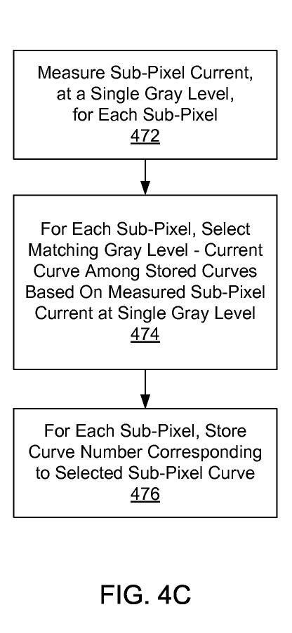

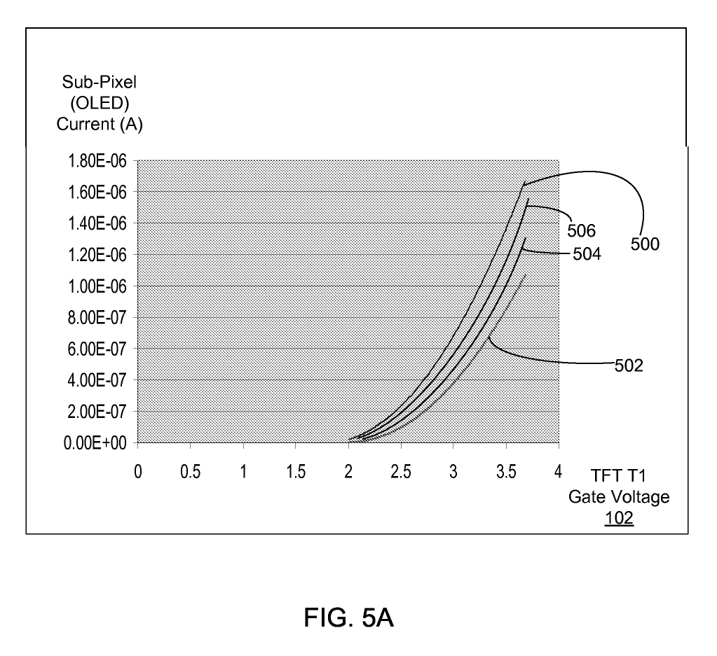

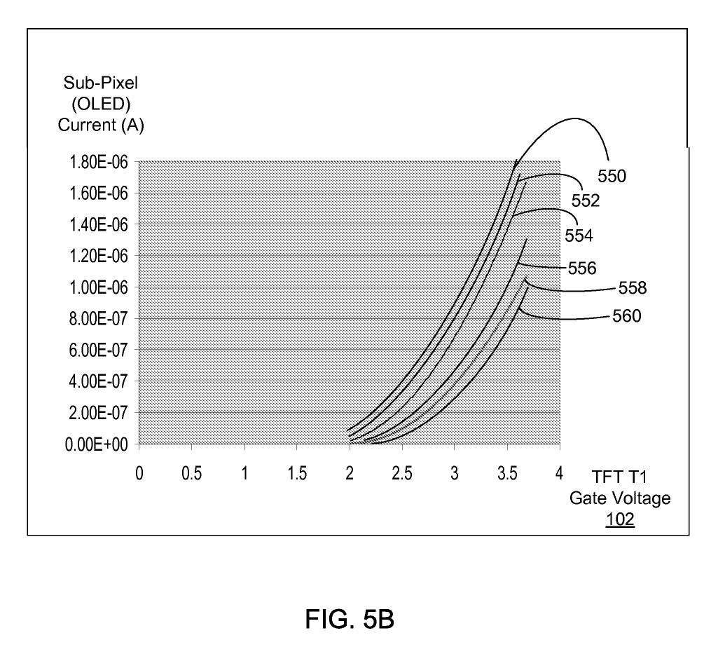

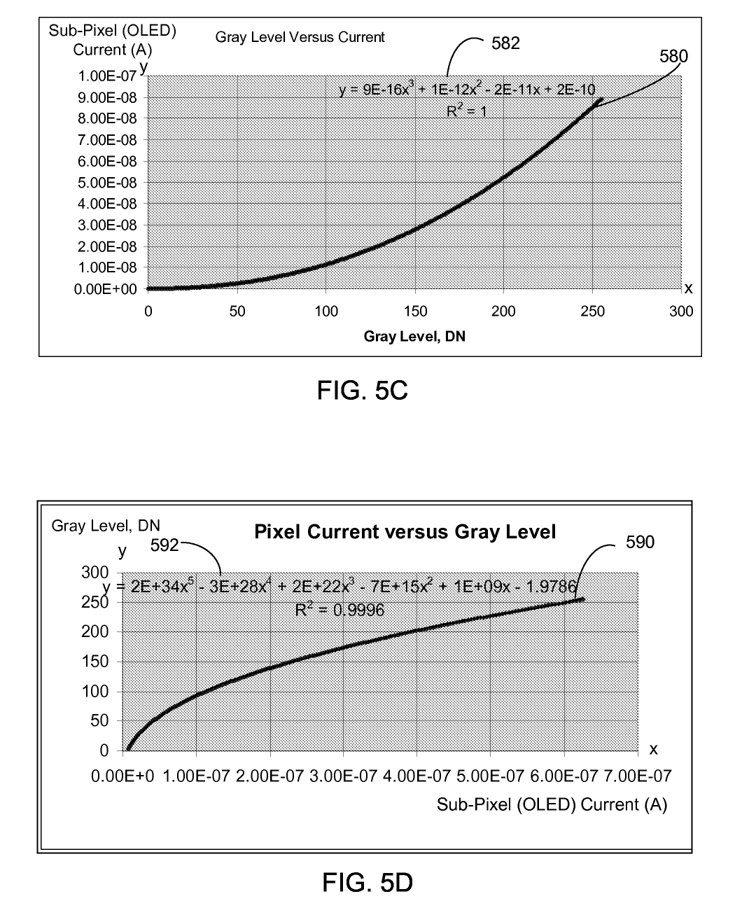

Turning to FIG. 4A, FIG. 4A is a flowchart illustrating a method of generating standard gray level-current curves of an AMOLED display, according to one embodiment of the present invention. First, the sub-pixel current of representative samples of OLED displays are measured 402 for each gray level, for each sub-pixel of the OLED displays. These representative samples of OLED displays are from a stable manufacturing process that would produce OLED displays with sub-pixels having consistent (albeit non-uniform) characteristics. One way of measuring the sub-pixel current of an OLED display is taught in U.S. patent application Ser. No. 11/710,462, filed by Walter Edward Naugler, Jr., et al. on Feb. 22, 2007 and entitled “Method and Apparatus for Managing and Uniformly Maintaining Pixel Circuitry in a Flat Panel Display,” which is incorporated by reference herein. However, note that other conventional methods of measuring the sub-pixel current of OLED display may be used with embodiments of the present invention. In one embodiment, multiple measurements of the sub-pixel current for each gray level are made and averaged to reduce random noise. Next, TFT T1 gate voltage (gray level) versus OLED current (sub-pixel) curves are then generated 404 for a pixel that exhibits lowest current and for a pixel that exhibits the highest current throughout the entire OLED display and the multiple OLED displays in the entire tested batch. Examples of such curves for the lowest current pixel and the highest current pixels are shown in FIG. 5A, which illustrates the standard gray level (T1 gate voltage)-current curves of an AMOLED display, determined by the method of FIG. 4A according to one embodiment of the present invention. In the example of FIG. 5A, the current curve for the lowest current pixel is curve 502 and the current curve for the highest current pixel is curve 500. Although the horizontal axis in FIG. 5A is indicated as the TFT T1 gate voltage, the graphs in FIG. 5A may use the DN (gray level data) on its horizontal axis plotted against the OLED current on its vertical axis, since the DN (gray level) is proportional to the TFT T1 gate voltage. In other words, the digital number, gray level, and the TFT T1 gate voltage are interchangeable herein.

Referring back to FIG. 4A together with FIG. 5A, intermediate gray level versus OLED current (sub-pixel) curves are then generated 406 by interpolation between the lowest current pixel curve 502 and the highest current pixel curve 500. In the examples shown in FIG. 5A, such intermediate curves are curves 504, 506. The number of intermediate curves 504, 506 to generate can be determined by the ratio (e.g., in percentages) of current on the highest current pixel curve 500 to the current on the lowest current pixel curve 502 for a given low gray level, for example, gray level 30, corresponding to a certain TFT T1 gate voltage 102. Such calculated ratio is divided by, for example, 5% to determine the number of curves required to have a guaranteed uniformity of less than 3%. This is because the human eye can detect a difference in brightness of 3% and the brightness of a pixel light emission is directly proportional to current, and thus two curves 5% apart (in current) will ensure that any pixel whose characteristics are characterized by either one of the two curves will have brightness error less than ±3% of any pixel closer to it than to the curves on either side. For example, such ratio may be calculated to be 632% (current on high current pixel curve is greater than current at low current pixel curve by 632%), in which case approximately 128 intermediate curves are generated to obtain a 5% difference between curves (i.e., 632/5=approximately 128). Note that the example of FIG. 5A shows only two intermediate curves 504, 506 for simplicity of illustration, although in reality there would be much more intermediate curves. The highest current pixel curve 500, the lowest current pixel curve 502, and the intermediate curves 504, 506 are the standard curves that characterize the gray level (TFT T1 gate voltage) versus sub-pixel (OLED) current of any sub-pixel of an OLED display produced by the tested manufacturing process. Any sub-pixel of any OLED display produced by the tested manufacturing process would likely have gray level (TFT T1 gate voltage) versus sub-pixel (OLED) current characteristics corresponding to at least one of the standard curves. The standard curves are constructed to have equal percentage difference between each of the curves. Note that the specific numbers used herein, such as the example gray level 30, the 5% difference between curves, and 3% for human eye sensitivity, are merely exemplary and different figures could be used that suit the production process and the desired display quality. In addition, although the gray level (TFT T1 gate voltage) versus sub-pixel (OLED) current characteristics are represented herein as “curves” for ease of illustration, any form or type of “mappings” between the gray level (or TFT T1 gate voltage) and the sub-pixel (OLED) current may be used to implement the present invention. Finally, the generated standard curves are stored 408, for example, in the form of a look-up table (LUT) including mappings between OLED current for different gray levels (or TFT T1 gate voltage), although the curves may be stored in other forms in a different format.

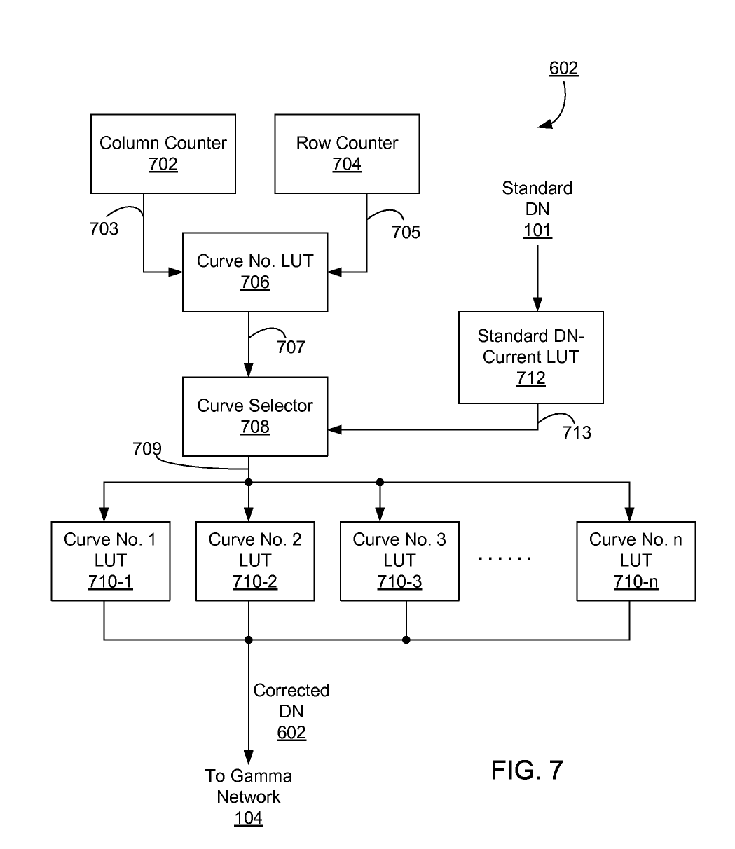

The generated standard current curves can be stored 408 in a variety of ways. In one embodiment, actual numbers for OLED current and the corresponding gray level (DN) together with the actual curve numbers are stored in memory, for example, in the form of an LUT (See e.g., FIG. 7, LUTs 710-1, 710-2, 710-3, . . . , 710-n). For example, one way to store the curves is to store a data point for each gray level on each curve, which would be 256 numbers for each curve in case of a 256 gray level display. In order to minimize the amount of memory needed, it is also possible to store the change in gray level relative to a previous gray level rather than the actual gray level itself. If there are 128 curves, the number of memory locations needed would be 32640. The memory needed to store the curve of each pixel in a wide VGA display, for example, would be 800 columns 3 colors 480 rows 7 bits=1,152,000·7 bits=approximately 8 Megabits (7 bits are needed to convert 128 base 10 to a binary number) with the embodiment of 4A.

In another embodiment, rather than storing the actual curve numbers for each pixel, the difference (delta) in the curve number for a specific pixel relative to the curve number for a preceding pixel is stored. That is, the first pixel in the row would have a specific curve number, but from that point the difference in the curve number relative to the curve number for a preceding pixel is stored for ensuing pixels in the row. For example, if the first pixel in the row is associated with curve number 150 and the second pixel in the row is associated with curve number 157, the curve number data stored for the second pixel is 7 (157−150) rather than curve number 157. This would be an efficient way to store the curve numbers for a large number of pixels, and works best for displays that have smooth changes of current characteristics from pixel to pixel rather than abrupt or step changes.

In still another embodiment, rather than storing actual numbers for OLED current and the corresponding gray level (DN) corresponding to the curves, such data is graphed, polynomial equations corresponding to such graphed data are developed through mathematical regression, and the coefficients of the polynomial equations are stored. Any conventional method of mathematic regression may be used to develop the polynomial equations.

FIG. 5C illustrates a gray level-current curve of an AMOLED display represented by a polynomial equation, according to one embodiment of the present invention. The example curve 580 shown in FIG. 5C has the gray level (DN) plotted on the x-axis and the resulting sub-pixel (OLED) current plotted on the y-axis. The mathematically regressed polynomial equation 582 is y=(9E−16)x³+(1E−12)x²−(2E−11)x+(2E−10), where the correlation coefficient R²=1. The equation 582 yields a sub-pixel current (y) for an input DN (x).

FIG. 5D illustrates a standard current-gray level curve of an AMOLED display represented by a polynomial equation, according to one embodiment of the present invention. The example curve 590 shown in FIG. 5D has the sub-pixel (OLED) current plotted on the x-axis and the corresponding gray level plotted on the y-axis. The mathematically regressed polynomial equation 592 is y=(2E+34)x⁵−(3E+28)x⁴+(2E+22)x³−(7E+15)x²+(1E+09)x−1.9786, where the correlation coefficient R²=0.9996. The equation 582 yields a DN (x) to obtain a particular sub-pixel current (y). The equation 592 of FIG. 5D is useful for determining the appropriate DN to use given a desired sub-pixel (OLED) current.

By using mathematical regression as shown in the examples of FIGS. 5C and 5D, the LUTs for storing the standard curves would not need 255 DN-current value pairs per curve but only 3 to 5 values corresponding to the coefficients of the polynomials of the equations. One caveat is that none of the actual curves 580, 590 go through zero current at the 0th gray level due to leakage in the off state of the current drive TFT T1, although the polynomial equations 582, 592 suggest zero current at the 0^{th} gray level. Thus, the equations 582, 590 may be less accurate at very low gray levels such as the 0^{th} gray level. Note that equation 582 in FIG. 5C does not have a correlation (R²) of 1 even though equation 582 is a higher order polynomial than the equation 592 in FIG. 5D. Also, in the case of active matrix emissive displays such as AMOLED displays, even a correlation coefficient rounded off to 1 may introduce errors in the 1% to 10% range.

Referring back to FIG. 4B, FIG. 4B is a flowchart illustrating a method of generating standard gray level-current curves of an AMOLED display, according to another embodiment of the present invention. First, the sub-pixel current of representative samples of OLED displays are measured 452 for each gray level, for each sub-pixel of the OLED displays, as in step 402 of FIG. 4A. It may be found that the distribution of TFT performance is not an even spread between the lowest current to the highest current, but may be bi-modal. In other words, there could be a group of pixels that cluster around the high current limit and another group of pixels that cluster around the low current limit. In this case, two groups may be established, each group with an upper current limit and a lower current limit. In this regard, sub-pixels are divided 454 into a high current group and a low current group, and the intermediate sub-pixels that fall between the high current group and the low current group are removed 454. Next, gray level versus OLED current (sub-pixel) curves are then generated 456 for the highest current pixel and the lowest current pixel in each of the high current group and the low current group. Examples of such curves for the lowest current pixel and the highest current pixel in each current group are shown in FIG. 5B, which illustrates the standard gray level-current curves of an AMOLED display, determined by the method of FIG. 4B according to one embodiment of the present invention. In the example of FIG. 5B, the current curve for the lowest current pixel of the high current pixel group is curve 554 and the current curve for the highest current pixel of the high current pixel group is curve 550. Similarly, the current curve for the lowest current pixel of the low current pixel group is curve 560 and the current curve for the highest current pixel of the low current pixel group is curve 556.

Referring back to FIG. 4B together with FIG. 5B, intermediate gray level versus OLED (sub-pixel) current curves are then generated 458 for each of the high current pixel group and the low current pixel group by interpolation between the lowest current pixel curve and the highest current pixel curve in each group. In the examples shown in FIG. 5B, such intermediate curves are curves 552, 558. Intermediate curve 552 is generated by interpolation between the highest current curve 550 and the lowest current curve 554 of the high current pixel group. Intermediate curve 558 is generated by interpolation between the highest current curve 556 and the lowest current curve 560 of the low current pixel group. The number of intermediate curves 552 to generate for the high current pixel group can be determined by the ratio (e.g., in percentages) of current on the highest current pixel curve 550 to the current on the lowest current pixel curve 554 for a given low gray level, for example, gray level 30, corresponding to a certain TFT T1 gate voltage 102. Similarly, the number of intermediate curves 558 to generate for the low current pixel group can be determined by the ratio (e.g., in percentages) of current on the highest current pixel curve 556 to the current on the lowest current pixel curve 560 for a given low gray level. Such calculated ratio is divided by 5% to determine the number of curves required to have a guaranteed uniformity of less than 3%. Note that the example of FIG. 5B shows only one intermediate curve 552 for the high current pixel group and only one intermediate curve 558 for the low current pixel group, for simplicity of illustration, although in reality there would be much more intermediate curves. The curves 550, 552, 554, 556, 568, 560 form the standard curves that characterize the TFT T1 gate voltage versus sub-pixel (OLED) current of any sub-pixel of an OLED display produced by the tested manufacturing process. Finally, referring back to FIG. 4B, the generated standard gray level versus sub-pixel current curves are stored 460, for example, in the form of a look-up table (LUT) including mappings between OLED current for different gray levels, although the curves may be stored in other forms in a different format. By removing 454 pixels that do not fall either in the high current pixel group or the low current pixel group, for example, if each current group uses a quarter of the difference between the highest current curve 550 and the lowest current curve 560, roughly one half of the pixels can be removed 454 and the number of curves that need to be generated are reduced to half. As a result, the number of bits required to designate a curve for each pixel is reduced, i.e., fewer curve numbers are needed. For instance, in the example given in FIGS. 4A and 5A, if 128 curves were needed to achieve the desired uniformity of the OLED display, 7 bits are needed to designate the curves as curve numbers and each sub-pixel would be assigned a 7 bit number to designate which standard curve to use for its correction. But if the sub-pixels fall into a high current pixel group or a low current pixel group, half the curves need not be generated and the number of bits needed to designate standard curves is reduced to 6. This reduces the amount of memory used in the OLED display.

FIG. 4C is a flowchart illustrating a method of using the standard gray level-current curves in an AMOLED display, according to one embodiment of the present invention. Once the standard curves for a production process are determined, only one current measurement needs be taken to determine which standard curve a specific pixel conforms to. Specifically, the sub-pixel current at a single gray level is measured 472 for each sub-pixel of the OLED display. The current or gray level at which this one point measurement is taken can be selected based on a trade-off between short integration time needed for current measurement at low gray levels and the high signal to noise ratio obtained from current measurements at high gray levels, which trade-off point may be determined empirically through testing of OLED displays early in the production history of a fabrication process.

Once the one-point measurement 472 is made, for each sub-pixel, a matching standard gray level versus OLED current curve is selected 474 among the standard curves generated through the process described, for example, in FIG. 4A or FIG. 4B. Then, for each sub-pixel, the curve number corresponding to the selected standard current curve is stored 476, so that the OLED display may use the selected current curve to correct non-uniformity in the corresponding sub-pixel caused by non-uniformities in the drive TFTs T1.

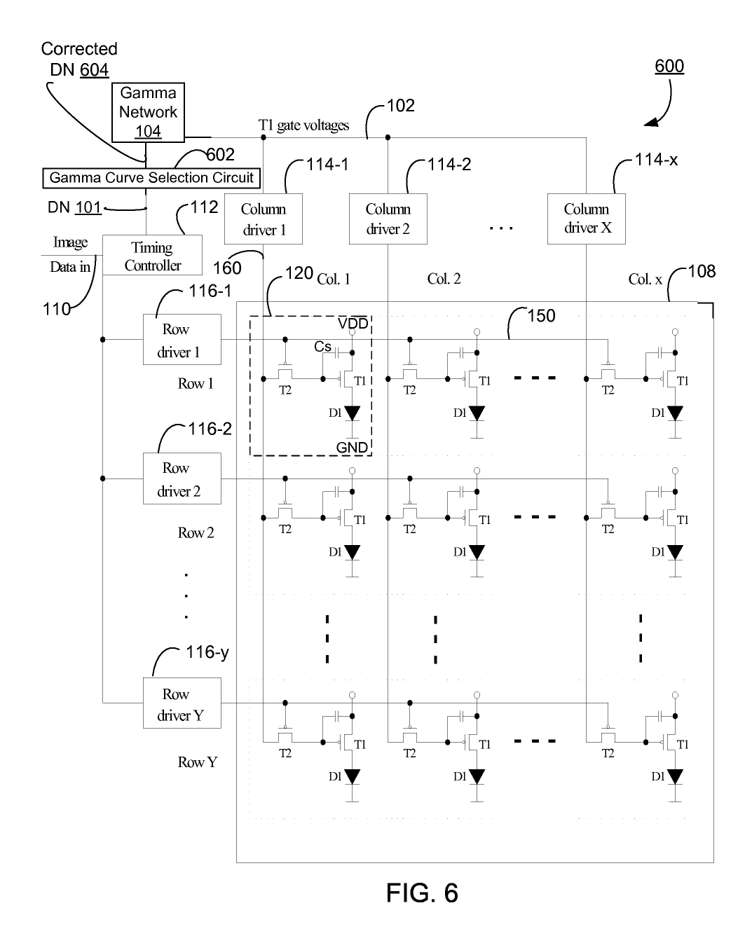

FIG. 6 illustrates an active matrix OLED display using the standard gray level-current curves, according to one embodiment of the present invention. The AMOLED display 600 of FIG. 6 is same as the AMOLED display of FIG. 1, with the exception that a gamma curve selection circuit 602 is added between timing controller 112 and gamma network 104 to generate a corrected digital number DN 604 based on the standard DN 101. As will be explained in more detail below with reference to FIG. 7, the gamma curve selection circuit 602 stores the standard current curves generated through the process described, for example, in FIG. 4A or FIG. 4B. For each sub-pixel of the OLED display 600, the gamma curve selection circuit 602 receives the standard DN 101 from timing controller 112, and selects one of the standard gray level-current curves stored therein to generate a corrected DN 604 based on the standard DN 101 using the selected standard current curve. The corrected DN 604 is provided through the gamma network 104 to the appropriate column driver (114-1, 114-2, . . . , or 114-x) under control of the timing controller 112.

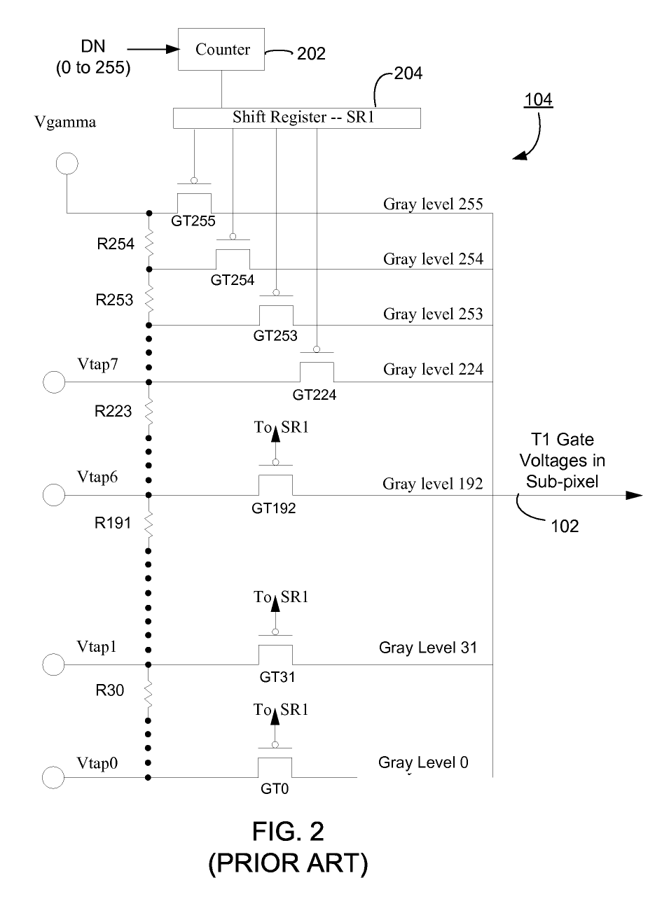

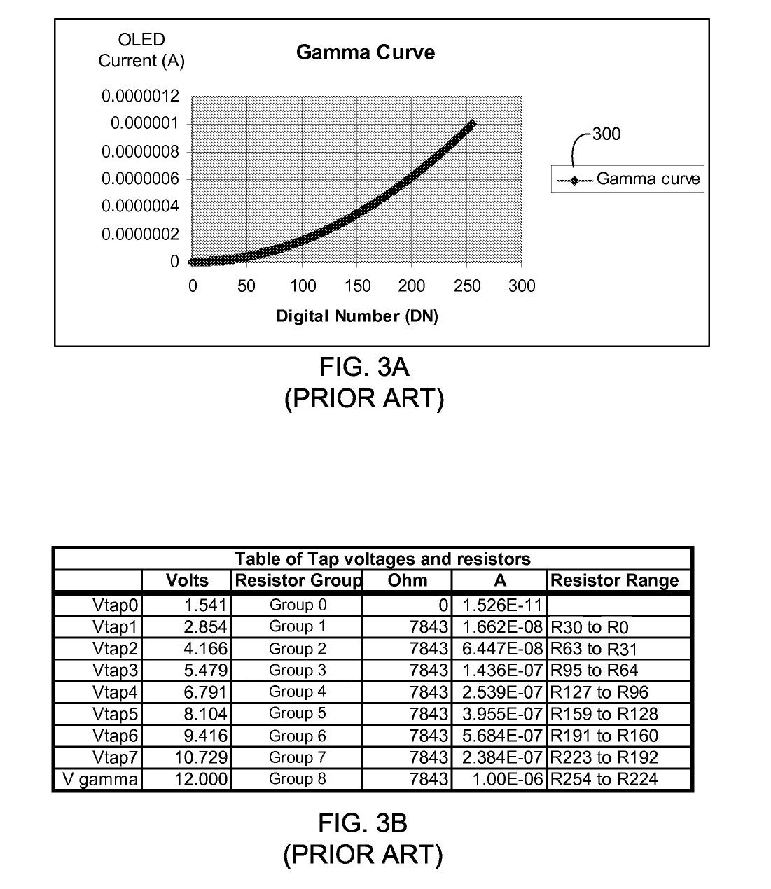

FIG. 7 illustrates the gamma curve selection circuit shown in FIG. 6 using the standard gray level-current curves in more detail, according to one embodiment of the present invention. The gamma curve selection circuit 604 includes a column counter 702, a row counter 704, curve number LUT 706, curve selector 708, standard curve LUTs 710-1, 710-2, 710-3, . . . , 710-n, and standard DN-current LUT 712. The row counter 704 and the column counter 702 keep track of which pixel in the OLED array is being driven, which pixel information is provided to curve number LUT 706. Curve number LUT 706 is a memory device storing the standard current curve numbers to use for each sub-pixel of the AMOLED display as determined by the method of FIG. 4C and stored in step 476. Curve number LUT 706 receives the row number 705 and the column number 703 of the sub-pixel of the OLED that is currently being driven, and selects and outputs the curve number 707 of the standard curve selected and stored for that sub-pixel. Curve selector 708 receives the selected curve number 707 and selects the corresponding one of the standard current curve LUTs 710-1, 710-2, 710-3, . . . , 710-n to be used to correct non-uniformities of the drive TFTs T1. For example, the selected curve number 707 may indicate that curve number 3 should be used to correct non-uniformities in the sub-pixel to be driven, in which case curve selector 708 selects curve no. 3 LUT 710-3. The column counter 702 and the row counter 704 indicate the exact sub-pixel, and the curve no. LUT 706 outputs a specific curve number 707 for that sub-pixel and sends it to the curve selector 708. Meanwhile, the standard DN 101 output from timing controller is input to standard DN-current converter LUT 712. Standard DN-current converter LUT 712 stores standard DNs and corresponding OLED sub-pixel current values in the form of an LUT, and outputs the corresponding OLED sub-pixel current value 713 based on the received standard DN 101 to the curve selector 708. The corresponding OLED sub-pixel current value 713 indicates the standard current value intended to be driven in the OLED sub-pixel. Curve selector 708 selects the appropriate standard curve LUT (710-1, 710-2, 710-3 . . . 710-n) based on the curve number 707 and also sends 709 the corresponding OLED sub-pixel current value 713 to the selected standard curve LUT. For example, the standard current curve LUT 710-3 selected by the curve selector 708 receives the desired OLED sub-pixel current value 713 and identifies the DN value corresponding to the desired OLED sub-pixel current value 713. The identified DN value is the DN value required to drive the OLED sub-pixel in order to obtain the desired OLED sub-pixel current value 713 that corresponds to the original standard DN 101 and the desired brightness of the OLED sub-pixel. The identified DN value is output from the selected curve LUT (e.g., 710-3) as the corrected DN 602 to the gamma network 104. For example, the corrected DN 602 is the DN value input to the counter 202 (See FIG. 2), when the gamma network 104 shown in FIG. 2 is used as the gamma network with the OLED display of FIG. 6.

According to the present invention, the amount of time needed to take measurements of the current characteristics of the OLED pixels is substantially reduced. By assigning OLED sub-pixels to one of a plurality of predetermined standard curves based on a single current measurement, a substantial amount of time may be saved in the OLED production calibration process.

### Gray Level Strategy

The popular number of gray levels in OLED displays is 256 (0 to 255). This is 8-bits per color, and therefore, a 24-bit color scheme in a three color process. When pixels have varying levels of brightness for the same gray level due to non-uniformity in the OLED drive TFTs T1, problems arise during correction. For example, a pixel that is weaker than the standard pixel can lack 10 or 20 gray levels at maximum gray level (DN=255). This means that these pixels should have DN numbers added to the specified DN number in order to increase their brightness to the standard level and will reach a corrected 255^{th} gray level well before the other pixels. These pixels will show flat highlights. Conversely, pixels that are brighter than the standard pixel will need to be corrected to lower gray levels. This means that at low gray levels these pixels will be corrected to the zero level 10 to 20 or more gray levels before the standard pixel. These pixels will lose detail in the shadow areas. There are several strategies that can be used for correction: (i) Make the best pixel the standard pixel and lose detail in the highlights, (ii) Make the worst pixel the standard pixel and lose detail in the shadows, (iii) Make a pixel somewhere between the low and high gray levels and split the loss of detail between the shadows and highlights, (iv) Add three bits to the color scheme, and run the OLED display with the usual 24-bit system but have available higher gray levels for the weak pixels (this strategy will have the best results with no loss of detail but entails higher cost), and (v) Correct loss of brightness by varying the brightness of the pixels around the dim pixel (dithering) to make up for missing light, in which case the human eye will average the light from the surrounding group of pixels, thereby producing uniformity in the low and middle gray levels.

Upon reading this disclosure, those of skill in the art will appreciate still additional alternative structural and functional designs for generating standard current curves for AMOLED displays. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of correcting non-uniformities of an active matrix drive circuit configured to drive current through a plurality of emissive display elements arranged in a matrix of a plurality of rows and a plurality of columns forming an emissive display, the method comprising
measuring sub-pixel current corresponding to a plurality of gray levels for a plurality of sub-pixels of the emissive display;
determining first mappings between the gray levels and the corresponding sub-pixel current for a highest current sub-pixel through which highest current flow is measured for a given gray level;
determining second mappings between the gray levels and the corresponding sub-pixel current for a lowest current sub-pixel through which lowest current flow is measured for the given gray level; and
determining third mappings between the gray levels and the corresponding sub-pixel current for one or more intermediate current sub-pixels with intermediate current flow between the lowest current flow and the highest current flow for the given gray level.

2. The method of claim 1, wherein the sub-pixel current is measured over a plurality of emissive displays manufactured from a manufacturing process.

3. The method of claim 1, wherein the third mappings are determined by interpolation of the first mappings and the second mappings at each of the gray levels.

4. The method of claim 1, wherein the gray levels are represented in the form of voltages applied to a drive transistor coupled to and configured to drive the sub-pixel current through a corresponding one of the emissive elements.

5. The method of claim 1, wherein the gray levels are represented in the form of digital numbers received from a graphics controller controlling the emissive display.

6. The method of claim 1, wherein the first mappings, the second mappings, and the third mappings are represented in forms of curves.

7. The method of claim 1, further comprising storing the first mappings, the second mappings, and the third mappings in a look-up table stored in a memory device.

8. The method of claim 1, wherein the first mappings, the second mappings, and the third mappings are stored with a mapping number to identify the mappings.

9. The method of claim 1, wherein the first mappings, the second mappings, and the third mappings are stored as mathematical equations approximating the first mappings, the second mappings, and the third mappings.

10. The method of claim 1, wherein number of third mappings is determined based upon a difference between the highest current flow and the lowest current flow for the given gray level and light sensitivity of a human eye.

11. The method of claim 1, further comprising grouping the measured sub-pixel current to a high current group and a low current group, and the first mappings, the second mappings, and the third mappings are determined within each of the high current group and the low current group.

12. The method of claim 1, further comprising:
measuring sub-pixel current corresponding to a single gray level for a plurality of sub-pixels of another emissive display to calibrate;
for each sub-pixel of said another emissive display, selecting one of the first mappings, the second mappings, and the third mappings as a matching mapping between the gray levels and the corresponding sub-pixel current;
for each sub-pixel of said another emissive display, storing the matching mappings in the emissive display.

13. The method of claim 12, further comprising converting digital numbers representing desired gray levels for the sub-pixels of the emissive display to corrected digital numbers using the stored matched mappings for each sub-pixel, the corrected digital numbers used in a gamma network to determine voltages to apply to drive transistors configured to drive the emissive elements of the emissive display.

14. The method of claim 1, wherein the emissive display is an active matrix organic light-emitting diode (AMOLED) display and the emissive elements are organic light-emitting diodes (OLEDs).

15. An emissive display device comprising:
a plurality of emissive display elements arranged in a matrix of a plurality of rows and a plurality of columns, each of the emissive display elements corresponding to a subpixel of the emissive display device; and
an active matrix drive circuit configured to drive current through the emissive display elements, the active matrix drive circuit including:
a mapping selection circuit storing a plurality of predetermined mappings between sub-pixel current corresponding to a plurality of gray levels for each of a plurality of sub-pixels of the emissive display device, the mapping selection circuit receiving data indicative of a desired gray level for a given sub-pixel and outputting corrected data corresponding to the desired gray level selected based upon one of the stored predetermined mappings between the sub-pixel current and the gray levels for the given sub-pixel;
circuitry receiving the corrected data and generating first voltage to be applied to the given sub-pixel;
a row driver for selecting the emissive display elements coupled to a selected row; and
a column driver receiving the first voltage and applying second voltage corresponding to the first voltage to a drive transistor configured to drive current through the emissive display element coupled to a selected column on the selected row.

16. The emissive display device of claim 15, wherein the mapping selection circuit comprises:
a plurality of memory devices storing the plurality of predetermined mappings between sub-pixel current corresponding to a plurality of gray levels for each of a plurality of sub-pixels of the emissive display device; and
a mapping selection module configured to select one of the memory devices based upon a row number and a column number of the sub-pixel to drive.

17. The emissive display device of claim 16, wherein the predetermined mappings between sub-pixel current corresponding to a plurality of gray levels are stored in the memory devices in forms of look-up tables.

18. The emissive display device of claim 17, wherein the look-up tables are configured to receive the data indicative of a desired gray level for the given sub-pixel and output the corrected data selected based upon one of the stored predetermined mappings for the given sub-pixel.

19. The emissive display device of claim 15, wherein the predetermined mappings include first mappings, second mappings, and third mappings that are determined by:
measuring sub-pixel current corresponding to a plurality of gray levels for a plurality of sub-pixels of the emissive display;
determining the first mappings between the gray levels and the corresponding sub-pixel current for a highest current sub-pixel through which highest current flow is measured for a given gray level;
determining the second mappings between the gray levels and the corresponding sub-pixel current for a lowest current sub-pixel through which lowest current flow is measured for the given gray level; and
determining the third mappings between the gray levels and the corresponding sub-pixel current for one or more intermediate current sub-pixels with intermediate current flow between the lowest current flow and the highest current flow for the given gray level.

20. The emissive display device of claim 19, wherein the third mappings are determined by interpolation of the first mappings and the second mappings at each of the gray levels.

21. The emissive display device of claim 19, wherein the first mappings, the second mappings, and the third mappings are stored in the memory devices with mapping numbers to identify the mappings.

22. The emissive display device of claim 19, wherein the first mappings, the second mappings, and the third mappings are stored as mathematical equations approximating the first mappings, the second mappings, and the third mappings.

23. The emissive display device of claim 19, wherein the measured sub-pixel current is grouped into a high current group and a low current group, and the first mappings, the second mappings, and the third mappings are determined within each of the high current group and the low current group.

24. The emissive display device of claim 19, wherein each sub-pixel is assigned one of the predetermined mappings based upon measured sub-pixel current corresponding to a single gray level.

25. The emissive display device of claim 15, wherein the emissive display is an active matrix organic light-emitting diode (AMOLED) display and the emissive elements are organic light-emitting diodes (OLEDs).
